(19) United States
(12) Patent Application Publication
(10) Pub. No.: US 2007/0106009 A1
(43) Pub. Date: May 10, 2007

(54) Thermosetting ultraviolet cut coating and film obtained therefrom

(75) Inventors: Takashi Okamoto, Osaka (JP); Masayoshi Ichinomiya, Matsuyama-shi (JP)

Correspondence Address: BIRCH STEWART KOLASCH & BIRCH, PO BOX 747, FALLS CHURCH, VA, 22040-0747, US

(73) Assignee: JTS CORPORATION, Matsuyama-shi (JP)

(21) Appl. No.: 11/269,652

(22) Filed: Nov. 9, 2005

(51) Int. Cl. C08G 18/42

(52) U.S. Cl. 524/500

(57) ABSTRACT

A thermosetting water-based ultraviolet cut coating which is excellent in film hardness, heat resistance, water resistance and chemical resistance and is gentle to human body and environment, composed of 5-150 parts by weight of an ultraviolet absorber (B), 3-100 parts by weight of an amino resin (C) and 0.01-20 parts by weight of an adhesion promoter (D) to 100 parts by weight of the solids content of an aqueous urethane resin (A), wherein the solids content concentration of the coating is 5-60% by weight, using water as a dispersion medium or a solvent.

### BACKGROUND OF THE INVENTION

1. Field of the Invention

The present invention relates to a coating for cutting ultraviolet rays suitable for applications which necessitate hardness, heat resistance, water resistance, chemical resistance and the like of a coating film. More particularly, the present invention is concerned with a thermosetting water-based ultraviolet cut coating based on an aqueous type resin emulsion which is gentle to human body and environment, and a coating film obtained therefrom.

2. Description of the Related Art

Recently, the toxicity to human body due to ultraviolet rays has been strongly recognized and its prevention has been keenly desired. Further, a wide variety of effective prevention methods have been addressed against the deterioration, the change of properties and the change of color in various types of components, members made of plastics as well as drinks, foods and the like due to ultraviolet rays.

As one of the prevention methods, a blend of an ultraviolet absorber into components and members or vessels for food and drink made of plastics, so called the mechanical blending is suggested. The mechanical blending can prevent the deterioration of components, members and vessels by ultraviolet rays, however, in order to prevent the deterioration, the change of properties and the change of color of food and drink in vessels, there is a need to blend a large amount of an ultraviolet absorber. The ultraviolet absorber blended therein bleeds out on the surface with a lapse of time, when such a large amount of the ultraviolet absorber is blended. Therefore, it is pointed out that as well as the performance for cutting ultraviolet rays is reduced, the ultraviolet absorber bled out may be introduced into food and drink, when used as a vessel for food and drink, resulting to a great problem from the aspect of safety and health. For such a use, it is effective that the ultraviolet cut coating capable of stably blending a large amount of an ultraviolet absorber is applied to the outer surface.

Also, an ultraviolet cut coating has been applied to a substrate such as a glass bottle in place of components, members and vessels made of plastics. Further, the ultraviolet cut coating has been applied to glass windows of office buildings, houses, automobiles and the like for the purposes of prevention of deterioration of furniture and furnishings, elimination of adverse effect to indoor residents and heat insulation. A certain level or more of hardness, water resistance, chemical resistance and the like is required as performance of a coating film because the coating film applied to these glass articles must be durable against the environment and conditions in which the coating is actually used. In order to meet these requirements and performance, an organic solvent type ultraviolet cut coating is used as disclosed, for example, in JP-A-7-196959. However, organic solvents are flammable to thereby cause a fire problem and are harmful to human body. Therefore, the measures against adverse effects to human body or environment due to repletion of a vaporized organic solvent within a building when applied or dried are strongly desired.

As one of measures, the applicant developed an aqueous ultraviolet cut coating, and applied the patent application that was disclosed as JP-A-2001-149845. This patent publication suggests a water-based and transparent acrylic type coating liquid material for cutting ultraviolet rays. The coating liquid material is obtained by emulsion polymerizing monomer components in the coexistence of an inorganic particulate which has high compatibility with glass such as colloidal silica to produce a high transparent acrylic type aqueous substrate, adding an ultraviolet absorber of the amount sufficient to absorb 95-100% of ultraviolet rays having a wavelength of 370 nm or shorter at a coating film thickness of 20 μm, wherein the blend is made so that the light transmittance to visible light rays at a film thickness of 10 μm is 90% or more. The acrylic type coating liquid material for cutting ultraviolet rays is excellent in transparency, ultraviolet absorptivity, water proofing property and adhesion to glasses, however, there are defects that the coating film is not sufficient in hardness and is easy to flaw.

### BRIEF SUMMARY OF THE INVENTION

It is an object of the present invention to provide a thermosetting water-based ultraviolet cut coating that solves the problems found in the aforementioned ultraviolet cut coating. It is also an object to provide a thermosetting water-based ultraviolet cut coating which is excellent in hardness, heat resistance, water resistance and chemical resistance of the coating film, and is gentle to human body and environment. It is also an object of the present invention to provide a coating film obtained therefrom.

The present inventors have accomplished the invention by focussing the attention on thermosetting water-based ultraviolet cut coatings with good storage stability. Because it is difficult for conventional water-based ultraviolet cut coatings, particularly the air drying coating to form a coating film having a balance on all aspects of coating film hardness, water resistance, chemical resistance and heat resistance.

Consequently, the present invention relates to a thermosetting water-based ultraviolet cut coating composed of 5-150 parts by weight of an ultraviolet absorber (B), 3-100 parts by weight of an amino resin (C) and 0.01-20 parts by weight of an adhesion promoter (D) to 100 parts by weight of the solids content of an aqueous urethane resin (A), wherein the solids content concentration of the coating is 5-60% by weight, using water as a dispersion medium or a solvent.

It is preferable that the aqueous urethane resin (A) above described is at least one selected from the group consisting of an ester type-, an ether type-, a polycarbonate type- and an acrylic complex type urethane resin.

Also, it is preferable that the ultraviolet absorber (B) above described is at least one selected from the group consisting of a salicylate type absorber, a benzophenone type absorber, a benzotriazole type absorber and a triazine type absorber.

Further, it is preferable that the amino resin (C) is at least one selected from the group consisting of a melamine resin, a urea resin, a urea glyoxal resin and a benzoguanamine resin.

Further, the adhesion promoter (D) is preferably a silane coupling agent.

In another aspect, the present invention relates to a coating film that is obtained by air drying the thermosetting water-based ultraviolet cut coating, followed by heating and curing the same.

The thermosetting water-based ultraviolet cut coating (hereinafter referred to as “the water-based coating” or “the coating”) of the present invention has following effects.

There is no problem in fire due to ignition, and in adverse effects to human body and environment since the present invention is a water-based ultraviolet cut coating. Also, it does not impart uncomfortable feelings and adverse effects to indoor residents, even if the coating is applied on the inner side of a window glass and a glass door of constructions or the glass of an automobile.

Also, since the present invention is a blend of the aqueous urethane resin (A) as a base resin, 5-150 parts by weight of the ultraviolet absorbent (B), 3-100 parts by weight of the amino resin (C) and 0.01-20 parts by weight of the adhesion prompter (D), using water as a dispersion medium or a solvent, the film coating obtained by conduct the heat-curing after air drying is excellent in adhesion to a substrate such as glasses, has the hardness as high as 3H or more of pencil hardness notwithstanding the water-based coating, has high transparency of 80% or more as transmittance of a visible light range at the time of a film thickness of 10 μm and has high ultraviolet absorption performance to cut 85% or more of ultraviolet rays with a wavelength of 370 nm or shorter.

Further, the coating film after the heat curing has high transparency of 80% or more as light transmittance at visible light range at a film thickness of 10 μm, has a pencil hardness of 3H or more and retains performance to cut 85% or more of ultraviolet rays with a wavelength of 370 nm or shorter even after the one hour immersion treatment in boiling water. Therefore, the coated drinking bottle can be sterilized by immersing it into boiling water for one hour.

As aforementioned, the thermosetting water-based ultraviolet cut coating of the present invention has comparable or surpassing coating film hardness, water resistance, chemical resistance and the like to solvent-based coatings and can be widely used in various applications.

### DETAILED DESCRIPTION OF THE INVENTION

Each component of the thermosetting water-based ultraviolet cut coating of the present invention will be described.

Aqueous urethane resin (A)

The aqueous urethane resins used in the present invention include various types of aqueous urethane resins such as the ester type, the ether type, the polycarbonate type, the acrylic complex type and the like. However, in order to accomplish the physical properties of the coating film after the thermosetting which is an object of the present invention, it is selected in consideration of coating film physical properties of the urethane resin. For the selection of the aqueous urethane resin, various types of aqueous urethane resins are applied to a transparent glass plate, then the heating treatment is conducted after air drying, for example, the coating films are prepared by heating at a temperature of 80-150° C. for one hour. Among these coating films, the coating films having a pencil hardness of H or more, preferably 2H or more are selected. Further, in order to select the aqueous urethane resin which is excellent in water resistance and chemical resistance, each coating film is immersed in water, ethanol, toluene, 10% aqueous NaOH solution and 10% aqueous acetic acid solution respectively at room temperature for 5 days. The aqueous urethane resin to form the coating film of which the extreme change of appearance such as transparency, configuration change or the like is not recognized is selected. As the aqueous urethane resin (A), preferably, the urethane resin that forms a high hardness coating film is selected among an ester type urethane resin and an ether type urethane resin.

The actual examples of commercial products of the aqueous urethane resin include, for example, ADEKA BONTIGHTER-HUX-232, HUX-240, HUX-320 and HUX-350 (available from ASAHI DENKA CO. LTD), HD-8208, HD-8261, HD-8284, HD-8533 and HD-8588 (available from C. L. Hauthaway and Sons Corporation).

As for the selected aqueous urethane resin aforementioned, in consideration of a combination of the aqueous urethane resin and the ultraviolet absorbent (B), it is finally selected. That is, the compatibility of various ultraviolet absorbers (B) with the aqueous urethane resin, which can be stably blended into the urethane resin, should be considered.

Ultraviolet absorber (B)

An ultraviolet absorber (B) has functions to absorb an incident ultraviolet ray and to delay the initiation of deterioration of a coating film by converting light energy to a nontoxic form such as heat. The ultraviolet absorber used in the present invention is preferably an organic ultraviolet absorber in consideration of transparency of a coating film and includes various ultraviolet absorbers such as salicylate type absorbers, benzophenone type absorbers, benzotriazole type absorbers and triazine type absorbers. It is selected by considering the compatibility with the aqueous urethane resin to be used.

The actual examples of the salicylate type absorbers include phenyl salicylate, p-octylphenyl salicylate, 4-tert-butylphenyl salicylate and the like.

The actual examples of the benzophenone type absorbers include 4-dihydroxybenzophenone, 2-hydroxy-4-metoxybenzophenone, 2,2′-di-hydroxy-4-methoxybenzophenone, 2-hydroxy-4-methoxy-2′-carboxybenzo-phenone, 2-hydroxy-4-methoxy-5-sulfobenzophenone trihydrate, 2,2′-di-hydroxy-4,4′-dimethoxybenzophenone, 2-hydroxy-4-octoxybenzophenone, 2-hydroxy-4-octadesiloxybenzophenone, sodium 2,2′-dihydroxy-4,4′-di-metoxy-5-sulfobenzophenone, 2,2′,4,4′-tetrahydroxybenzophenone, 4-dodecyloxy-2-hydroxybenzophenone, 5-chloro-2-hydroxybenzophenone, resorcinol monobezoate, 2,4-dibenzoylresorcinol, 4,6-dibenzoylresorcinol, hydroxydodecylbenzophenone, 2,2′-dihydroxy-4(3-methacryloxy-2-hydroxypropoxy)benzophenone and the like.

The actual examples of the benzotriazole type absorbers include 2-(2′-hydroxy-5′-methylphenyl)benzotriazole, 2-(2′-hydroxy-5′-t-butylphenyl)-benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′,5′-di-t-amylphenyl)benzotriazole, 2-(2′-hydroxy-4′-octoxyphenyl)benzotriazole, 2-{2′-hydroxy-3′-(3″,4″,5″,6″-tetrahydrophthalimidomethyl)-5′-methylphenyl} benzotriazole and the like.

The actual examples of the triazine type absorbers include 2,4-bis(2,4-dimethylphenyl)-6-(2-hydroxy-4-isooctyloxyphenyl)-1,3,5-triazine, 2-[4((2-hydroxy-3-dodecyloxypropyl)-oxy)-2-hydroxyphenyl] -4,6-bis(2,4-dimet hylphenyl)-1,3,5-triazine, 2-[4-((2-hydroxy-3-tridecyloxypropyl)oxy)-2-hydroxyphenyl]-4,6-bis(2,4-dimethylphenyl)-1,3,5-triazine, 2-(2,4-di-hydroxyphenyl)-4,6-bis(2,4-dimethylphenyl)-1,3,5-triazine and the like.

Among those described above, 2-(2′-hydroxy-5′-t-buthylphenyl)-benzotriazole and its derivatives, 2-(2′-hydroxy-3′,5′-di-t-butylphenyl)-benzotriazole and its derivatives are preferable.

The ultraviolet absorber is also selected in consideration of functions of the ultraviolet absorber, for example, the ultraviolet wavelength absorption range. It is important that the ultraviolet absorber is used alone, in a state of a mixture with other ultraviolet absorbers or in a state of the complex form. Benzotriazole type ultraviolet absorbers are mainly used. The amount of the ultraviolet absorber to be blended depends on the type of ultraviolet absorber to be used, namely, the absorption properties or the absorption wavelength range that the ultraviolet absorber has. Usually, 5-150 parts by weight of the ultraviolet absorber is blended to 100 parts by weight of the solids content included in the aqueous urethane resin (A). When the amount of the ultraviolet absorber is less than 5 parts by weight, performance for cutting ultraviolet rays of the coating is insufficient. On the other hand, when the amount of the ultraviolet absorber is more than 150 parts by weight, it bleeds out easily from the coating film or the hardness of the coating film may sometimes be reduced. Usually, the amount to be blended is preferably 10-100 parts by weight, more preferably 20-80 parts by weight.

Amino resin (C)

The amino resin (C) used in the present invention as a thermosetting agent includes various aqueous amino resins such as melamine resins, urea resins, urea glyoxal resins and benzoguanamine resins. However, any amino resin that has good compatibility with the aqueous urethane resin (A) having the above-mentioned ultraviolet absorber formulated therein, forms a colorless transparent coating film and forms a coating film with a pencil hardness of 3H or more while retaining the transparency when the thermosetting treatment is conducted is selected. Upon selecting the amino resin (C), there are criteria: an amino resin that gives no adverse effect to the storage stability, namely, it is stable and abnormality is not recognized even if the coating is left as it is for 10 days or more, further preferably one month or more when it is stored in a sealed condition at a temperature of 40±1° C. Further, it is selected by the criteria that the transparency of the coating film that has been finally subjected to heat curing is not lost and the pencil hardness is 3H or more. Among amino resins, the amino resin (C) that satisfy the above selection criteria are suitable. Also, various compounds to promote the thermosetting reaction along with the amino resin, that is, various catalysts may be blended.

The amount of the amino resin (C) to be blended is different depending on the type of the amino resin to be used. However, it is preferable that 3-100 parts by weight, preferably 5-80 parts by weight of the amount of the amino resin to be blended may be used based on 100 parts by weight of the solids content of the aqueous urethane resin (A). When the amount is less than 3 parts by weight, the performance such as film hardness, water resistance, chemical resistance and the like is likely to become insufficient. On the other hand, when the amount is more than 100 parts by weight, the storage stability at a temperature of 40±1° C. is disadvantageously getting worse. Therefore, these cases are undesirable.

Adhesion promoter (D)

The adhesion prompter (D) is added to a system of the aqueous urethane resin (A)/the amino resin (C)/the ultraviolet absorber (B) because the adhesion to a glass plate or a glass bottle is insufficient. In this case, there provided problems in that the coating film sometimes loses transparency or has poor stability. So called a silane coupling agent having an alkoxy silyl group and an organic functional group in the molecule is useful as an adhesion prompter used in the present invention. The silane coupling agent includes various silane coupling agents such as amino type, ureido type, epoxy type, isocyanate type, vinyl type, methacryl type, mercapto type silane coupling agents and the like. Upon selecting these silane coupling agents, it is necessary to select them in consideration of transparency, coating storage stability and coating film physical properties as similar to the case of the amino resin (C) selection. The amount of the adhesion promoter (D) to be blended is different depending on the type of the coupling agent to be used. Usually, the adhesion promoter is blended so that the effective amount of the adhesion promoter becomes 0.01-20 parts by weight, preferably 0.05-10 parts by weight based on 100 parts by weight of the solids content of the aqueous urethane resin. In this occasion, when the amount to be blended is less than 0.01 parts by weight, the adhesion to a substrate such as glasses is insufficient and when the amount to be blended is more than 20 parts by weight, the storage stability of the coating is getting worse.

The amino type silane coupling agents among the silane coupling agents aforementioned include γ-aminopropyltriethoxysilane, γ-amino-propyltrimethoxysilane, N-(β-aminoethyl)-γ-aminopropyltrimethoxysilane and γ-phenylaminopropyltrimethoxysilane; the ureido type silane coupling agent includes ureidopropyltriethoxysilane and ureidopropyl-trimethoxysilane; the epoxy type silane coupling agent includes β-(3,4-epoxycyclohexyl)ethyltriemethoxysilane, γ-glycidoxypropyltrimethoxy-silane, γ-glycidoxypropyltriethoxysilane, γ-glycidoxypropylmethyl-dimethoxysilane and γ-glycidoxypropylmethyldiethoxysilane; the isocyanate type silane coupling agent includes γ-isocyanatepropyltriethoxysilane and γ-isocyanatepropyltrimethoxysilane; the vinyl type silane coupling agent includes vinyltriethoxysilane, vinyltrimethoxysilane, vinyltris(β-methoxyethoxysilane) and vinylmethyldimethoxysilane; the methacryl type silane coupling agent includes γ-methacryloxypropyltrimethoxysilane, γ-methacryloxypropyltriethoxysilane and γ-methacryloxypropylmethyl-dimethoxysilane; the mercapto type silane coupling agent includes γ-mercaptopropyltrimethoxysilane and γ-mercaptopropyltriethoxysilane. Among these, γ-aminopropyltriethoxysilane and γ-aminopropyltri-methoxysilane are preferably used.

Water

Besides (A)-(D) components aforementioned, water is included in the coating of the present invention as a dispersion medium or a solvent of these (A)-(D) components.

City water, ion exchanged water, distilled water and the like is usable as water.

Further, additives such as a surfactant, a leveling agent, a defoamer, a viscosity modifier and an antioxidant may be added to the coating comprising the basic composition aforementioned, as needed. Each the constituting component and the amount to be blended is selected as following essential conditions that the coating film obtained by applying liquids with a variety of amounts to be blended of each component to a glass plate has a pencil hardness of the coating film is 3H or more, that the light transmittance of the visible light range at a film thickness of 10 μm is 80% or more and that the coating film cuts 85% or more of ultraviolet rays with a wavelength of 370 nm or shorter. Further, in applications for coating glass bottles for drinking, there a case wherein the coated bottle is subjected to an immersion treatment in boiling water for one hour for the purpose of sterilization. Therefore, even if the coated and heat-cured glass plate is immersed in boiling water for one hour, the coating films that cannot not be stripped from the glass substrate while retaining identical performance such as hardness, tranparency, ultraviolet cutting performance to those before or after the boiling water treatment are selected.

As the surfactant, anionic surfactants such as sulfonic acid type, sulfonate type and phosphoric acid ester type surfactants; cationic surfactants such as tertiary cationic type, imidazole type and amineoxide type surfactants; nonionic type surfactants such as alkylphenolethyleneoxide type, alcoholethylene oxide type, propyleneoxide-etyleneoxide copolymer type, aliphatic acid ester type, amide type surfactants and polyethylene glycol; and betaine type amphoteric surfactants are preferably used. As the leveling agent, organic modified polysiloxane compounds and fluorocarbon modified acrylic compounds that are compatible with water are preferably used. As the defoamer, defoamers comprised of an organic polymer and an organic metal compound which are compatible with water, and defoamers comprised of a modified silicone type compound are preferably used. As the viscosity modifier, polycarboxylic acid amide type compounds and specifically modified urea compounds are preferably used. As the antioxidant, hindered phenol type compounds and hindered amine type compounds are preferably used respectively.

The preparation method of the coating of the present invention comprises adding the ultraviolet absorber (B) that is dissolved in a particular solvent to the aqueous urethane resin (A) with mixing to dissolve the ultraviolet absorber in the urethane resin and then blending the additives such as a leveling agent and the like thereto, as needed, thereby firstly preparing an ultraviolet cut coating. In this occasion, the adjustment is properly made so that a predetermined concentration of the solids content is acquired by adding water. After that, the amino resin (C) is uniformly added with agitation, then the adhesion promoter (D) is added with agitation to prepare the coating liquid of the present invention. The order of the addition of the amino resin (C) and the adhesion promoter (D) may be reversed or may be simultaneously added. Then, this liquid is filtrated through a filter, for example, with a mesh of 1 μm to purify. The concentration of the solids content of the coating of the present invention is properly adjusted depending on the applications to be used. However, the application method is normally adjusted so that it becomes 5-60 parts by weight, preferably 15-40 parts by weight by adding water as a dispersion medium or a solvent.

The substrates for applying the coating of the present invention include various substrates with relatively high hardness, which requires a function for cutting ultraviolet rays such as hard plastics, wood products, concrete products and the like besides glass articles such as window glasses or glass bottles and the like.

The use to utilize the effects of the present invention will be actually explained as compared with the prior arts.

In recent years, the recognition to toxicity of ultraviolet rays has increased, it has been widely prevailed that films in which ultraviolet absorbers have been blended are stuck on window glasses of general households, buildings, automobiles, rail ways, vehicles such as buses and the like or coatings are applied thereto. In case of films, there are problems in that seams occur in sticking the film on a large window, the blended ultraviolet absorber bleeds out, thereby deteriorating the performance for cutting ultraviolet rays and cannot endure the use for a long term and flaws are easily generated. On the other hands, the conventional method for applying the coating with UV cut function on window glasses can obtain the seamless films excellent in durability, however, the surface hardness of the coating film is low and is easily scratched by nails or the like. Therefore, the present situation is that the use range is extremely limited. The present invention has high hardness of the film, is not easily scratched by nails, further is excellent in water resistance, chemical resistance and UV cut properties and the effects maintains for a long term. Therefore, the present invention is suitable for the coating on various window glasses aforementioned.

It is known that drink products such as liquor and wine are discolored and deteriorated on taste, and further, foods and cosmetics are similarly changed in quality or deteriorated by ultraviolet rays. As this countermeasure to this degradation, it is conducted that the bottle itself is opacified or the containers themselves such as glass bottles are pigmented in colors that are difficult for ultraviolet rays to transmit. Further, although the skilled in the art recognizes that there are fire problems and adverse effects to human body and environment when ultraviolet cut coatings are applied to the surface of containers, solvent-based ultraviolet cut coatings are used in consideration of film hardness, water resistance, chemical resistance and the like. The present invention, however, is able to improve fire issues and adverse effects to human body and environment due to solvents, and has high hardness so that the coating is hard to be scratched by nails and is excellent in UV cutting ratio and hot water resistance. Therefore, the present invention is suitable for use in coating the aforementioned various glass bottles or containers.

Also, various types of plastic products and concrete products are deteriorated and are getting brittle due to ultraviolet rays when exposed to sunlight for a long time. Also a wooden products such as a plain wood is sun burned and discolored when exposed to sunlight for a long term. So the outward appearance is getting worse. However, the coating of the present invention has high hardness and high UV cutting ratio to prevent the deterioration and the discoloring due to ultraviolet rays and the effects maintains for a long time, therefore, it is suitable for coating these substrates.

As for the coating methods to apply the coating of the present invention, there are flow coating method, bar coating method, immersion method, spray coating method and the like. Those methods can be properly practiced and selected depending on their uses and profiles. The coated film that is excellent in hardness, water resistance and chemical resistance can be obtained by conducting a heat treatment such as hot air drying method and far infrared ray heater method to cause the thermosetting reaction. The heat temperature on this case is different in accordance with the types of urethane resins and amino resins to be used and the necessity of adding a curing catalyst, however, normally it is preferred that the coating can be cured at a range of 60-200° C., preferably a range of 80-160° C.

The amount of the coating to be applied of the present invention is normally 3-50 g/m², preferably 10-30 g/m² calculated in terms of the solids content. Because the specific gravity of the coating is about 1, the film thickness when dried is 3-50 μm, preferably 10-30 μm. The application of the coating by the methods described above can be normally finished at one time, also may be applied in two or more times.

Heretofore, clear transparent type thermosetting water-based coating for cutting ultraviolet rays of the present invention is explained. It is also possible that various pigments and dyes are blended into the coating. It is needless to say that the light transmittance of a visible light ray range may become 80% or less depending on pigments or dyes to be used.

### EXAMPLES

### Example 1

### Selection of Aqueous Urethane Resin

The coating films were prepared by applying various aqueous urethane resins to a transparent glass plate and air drying, and then heating the coated substrate at a temperature of 100° C. for 1 hour. The coating film of the urethane resin having a pencil hardness of H or more was selected among these coating films. Then, the coated substrate of the selected resin was immersed in water, ethanol, toluene, an aqueous 10% NaOH solution and an aqueous 10% acetic acid solution for 5 days. Among these, the aqueous urethane resin I (ADEKA BONTIGHTER-HUX-232 available from ASAHI DENKA CO., LTD) which formed the coating with no change of extreme outside appearance such as transparency, profile change and the like to be recognized was selected.

### Preparation of Coating A

To 100 parts by weight of the solids content of the aqueous urethane resin I, 30 parts by weight of a benzotriazole type ultraviolet absorber, TINUVIN1130 (available from CHIBA SPECIALTY CHEMICALS KK.) was blended. A coating A was prepared by adding a water having a silicone type leveling agent dissolved to the resulting formulation to adjust so that the total solids content concentration became 30%, followed by the filtration using a filter with the mesh of 1 μm.

The coating A was applied to a glass plate so that the film thickness after drying became 10 μm. The air dried coating film cut 95% or more of ultraviolet rays of a wavelength of 370 nm or shorter and the light transmittance of the visible light range was 85-90%. The pencil hardness of the coating was H.

### Selection of Amino Resin and Preparation of Coating B

Various amino resins were blended into the aforementioned coating A. Further, the melamine type amino resin, Cymel 303 (available from NIHON CYTEC INDUSTRIES INC.) was selected from the viewpoint of the storage stability at a temperature of 40±1° C. and transparency of the coating film. Next, the amount of the effective component of the selected melamine type amino resin was blended so that it became 20 parts by weight based on 100 parts by weight of the solids content of the aforementioned aqueous urethane resin I, mixed with agitation, then the resulting mixture was filtrated through a filter of which the mesh is 1 μm to prepare the coating B.

The coating B was applied to a transparent glass plate so that the film thickness after drying became 10 μm and heat treated at 150° C. for 30 minutes to prepare a colorless transparent coating film. The colorless transparent coating film had a pencil hardness of 3-4H, and the ultraviolet cut performance and the light transmittance of the visible light range were almost similar to those of the coating A. Cellotape peeling test (coated films on a glass plate are crosscut at a width of 1 mm in 100 teeth, a piece of cellotape is stuck thereon, the strip of the tape is peeled to determine the peeled degree) as adhesion to a glass plate of the coating film showed failure that all the coating films were peeled. Also, the coating film which was applied to the glass plate and heat cured was subjected to the immersion treatment in boiling water for one hour. It was recognized that the coating film was peeled.

### Selection of Adhesion Promoter and Preparation of Coating of the Present Invention

In the similar procedure to the case of the selection of the amino resin, the amino type silane coupling agent, A-1106 which is available from Nippon Unicar Company Limited was selected from the criteria of storage stability of the liquids by blending the various silane coupling agents into the aforementioned coating B.

The amount of the effective component of the aforementioned selected amino type silane coupling agent was blended so that it became 3 parts by weight based on 100 parts by weight of the solids content of the aqueous urethane resin I, mixed with agitation, then the resultant mixture was filtrated through a filter of which the mesh is 1 μm to prepare the coating of the present invention. The coating was left standing in an incubation tank at 40±1° C. in a sealed state, however, there were not recognized any abnormality such as gelation, precipitation and separation even after one month elapsed.

The coating of the present invention was applied to a glass plate so that the film thickness after drying became 10 μm and heat treated at 150° C. for 30 minutes to prepare a colorless transparent coating film. The pencil hardness of the coating film was 3-4H. The coating film cut 90% or more of ultraviolet rays of a wavelength of 370 nm or shorter and the light transmittance of the visible light range was 80-85%.

The adhesion to glass of the coating is good, and the aforementioned Cellotape test did not reveal any peeling. Further, even after the applied and heat cured film on the glass plate was immersed in boiling water for one hour and then air dried, the performance of the coating film such as pencil hardness, strippable properties, ultraviolet cutting properties and the light transmittance of visible light range was almost same as those of the coating film before the treatment.

### Example 2

### Selection of Aqueous Urethane Resin

In accordance with the selection criteria of Example 1, HD-8261 available from C. L. Hauthaway and Sons Corporation as the aqueous urethane resin II was selected.

### Preparation of Coating C

Fifty parts by weight of the benzotriazole type ultraviolet absorber, TINUVIN 1130 which is available from CHIBA SPECIALTY CHEMICALS KK was blended into the aqueous urethane resin II based on 100 parts by weight of the solids content of the aqueous urethane resin II. A water solution having a silicone type leveling agent dissolved by mixing was added to the aforementioned blend so that the total solids content concentration became 25% and then filtrated through a filter of which the mesh is 1 μm to prepare the coating C.

The coating C was applied to a transparent glass plate so that the film thickness after drying became 10 μm. The air dried coating film cut 90% or more of ultraviolet rays of a wavelength of 380 nm or shorter and the light transmittance of the visible light range was 80-85%. The pencil hardness of the coating was 2 H.

### Selection of Amino Resin and Preparation of Coating D

In accordance with the aforementioned criteria, the amino resin, Watersol S-695 available from DAINIPPON INK AND CHEMICALS INC. was selected. Next, the amount of the effective component of the selected amino resin was blended so that it became 25 parts by weight based on 100 parts by weight of the solids content of the aforementioned aqueous urethane resin II, mixed with agitation, then the resulting mixture was filtrated through a filter of which the mesh is 1 μm to prepare the coating D.

The coating D was applied to a transparent glass plate so that the film thickness after drying became 10 μm and heat-treated at 150° C. for 30 minutes to prepare a colorless transparent coating film. The colorless transparent coating film had a pencil hardness of 4-5H, the ultraviolet cut performance and the light transmittance of the visible light range were almost similar to those of the coating C. Cellotape peeling test showed failure. When the coating film was immersed in boiling water, it was recognized that the coating film was peeled.

### Selection of Adhesion Promoter and Preparation of Coating of the Present Invention

Various types of silane coupling agents were blended into the coating D. AY43-031H, available from Dow Corning Toray Company was selected from the viewpoint of storage stability of the liquid and transparency of the coating film.

The amount of the effective component of the aforementioned selected silane coupling agent was blended so that it became 2 parts by weight based on 100 parts by weight of the solids content of the aqueous urethane resin II, mixed with agitation, then the resulting mixture was filtrated through a filter of which the mesh is 1 μm to prepare the coating of the present invention. The coating was left standing in an incubation tank at 40±1° C. in a sealed state, however, there were not recognized any abnormality such as gelling, precipitation and separation even after one month lapsed.

The coating of the present invention was applied to a glass plate so that the film thickness after drying became 10 μm and heat treated at 150° C. for 30 minutes to prepare a colorless transparent coating film. The pencil hardness of the coating film was 4-5H. It was recognized that the coating film could not be almost scratched by nail. The coating film cut 90% or more of ultraviolet rays of a wavelength of 380 nm or shorter and the light transmittance of the visible light range was 80-85%.

The adhesion to glass of the coating was good. The aforementioned Cellotape test did not reveal any peeling. Further, even after the applied and heat cured film on the glass plate was immersed in boiling water for one hour and then air dried, the performance of the coating film such as pencil hardness, ultraviolet cutting properties and the light transmittance of visible light range was almost same as those of the coating film before the treatment

The present invention is not limited to the foregoing embodiments, and it is understood that variations and modification can be made without departing from the gist of the invention.

1. A thermosetting water-based ultraviolet cut coating composed of 5-150 parts by weight of an ultraviolet absorber (B), 3-100 parts by weight of an amino resin (C) and 0.01-20 parts by weight of an adhesion promoter (D) to 100 parts by weight of the solids content of an aqueous urethane resin (A), wherein the solids content concentration of the coating is 5-60% by weight, using water as a dispersion medium or a solvent.

2. The thermosetting water-based ultraviolet cut coating according to claim 1, wherein said aqueous urethane resin (A) is at least one selected from the group consisting of an ester type, an ether type, a polycarbonate type and an acrylic complex type resin.

3. The thermosetting water-based ultraviolet cut coating according to claim 1, wherein said ultraviolet absorber (B) is at least one selected from the group consisting of a salicylate type absorber, bonzophenone type absorber, a benzotriazole type absorber and a triazine type absorber.

4. The thermosetting water-based ultraviolet cut coating according to claim 1, wherein said amino resin (C) is at least one selected from the group consisting of a melamine resin, a urea resin, a urea glyoxal resin and a bezoguanamine resin.

5. The thermosetting water-based ultraviolet cut coating according to claim 1, wherein said adhesion promoter (D) is a silane coupling agent.

6. A coating film obtained by air-drying said thermosetting water-based ultraviolet cut coating according to any one of claims 1 through 5, and then heat curing the same.
